(19) United States
(12) Patent Application Publication
(10) Pub. No.: US 2005/0135845 A1
(43) Pub. Date: Jun. 23, 2005

(54) Multicolor printing system

(76) Inventors: Bernd Schultheis, Schwabenheim (DE); Holger Kobrich, Florsheim (DE); Dieter Jung, Daaden (DE)

Correspondence Address: Pauley Petersen & Erickson, Suite 365, 2800 W. Higgins Road, Hoffman Estates, IL, 60195, US

(21) Appl. No.: 10/993,403

(22) Filed: Nov. 19, 2004

(30) Foreign Application Priority Data
Nov. 20, 2003 (DE) 103 54 345.7

(51) Int. Cl. G03G 15/01

(52) U.S. Cl. 399/302

(57) ABSTRACT

A multicolor printing system with a plurality of toner printing stations which apply differently colored toner images to at least one side of a transfer medium, from where the toner images can be transferred to a print medium which can be contacted with the transfer medium. If an endless transfer belt is used as the transfer medium, with a running direction extending at an angle with respect to the transport direction of the print medium, the toner printing stations embodied as modular units are arranged at exteriors of two sides of the endless transfer belt and are matched to the opposing running directions of the sides with the toner image transfer, and the multicolor toner image of the endless transfer belt can be transferred directly or via a transfer roller to the print medium which is conducted at the same speed as the endless transfer belt, then it is possible with small structural dimensions to arrange a plurality of toner printing stations in an easily accessible manner at the endless transport belt and to control them so that a congruent composition of the multi-color toner image and its unequivocal transfer to the print medium occurs.

### BACKGROUND OF THE INVENTION

1. Field of the Invention

This invention relates to a multicolor printing system with a plurality of toner printing stations which apply differently colored toner images to at least one side of a transfer medium, from where the toner images can be transferred to a print medium which can be brought into contact with the transfer medium.

2. Discussion of Related Art

Multicolor printing systems are known, wherein the printing stations are arranged one behind the other and wherein the medium to be imprinted is conducted beyond the printing stations and is sequentially imprinted with the differently colored partial toner images, such as is shown in European Patent References EP 0 896 256 A2 and EP 0 827 043 A2, for example. In connection with large-format printing, such a multicolor printing system takes up a very large amount of space and is thus not suited for use in an office, for example. The same applies to a multicolor printing system taught by U.S. Pat. No. 5,805,967.

### SUMMARY OF THE INVENTION

It is one object of this invention to provide a multi-color printing system of the type mentioned above but which has a structural size suitable for office applications or as compact production machinery, which does not require the air-conditioning of the print media and yet can be used for an endless color transfer, along with satisfactory accessibility of the components used.

This object is achieved with this invention that has an endless transfer belt used as the transfer medium, with a running direction that extends at an angle with respect to the transport direction of the print medium. The toner printing stations, embodied as modular units, are arranged at the exteriors of the two sides of the endless transfer belt and are matched to the opposing running directions of the sides with the toner image transfer. The multicolor toner image of the endless transfer belt can be transferred directly or via a transfer roller to the print medium which is conducted at the same speed as the endless transfer belt.

With the arrangement of the toner printing stations at the endless transfer belt and the matching of the toner printing stations to the facing running direction of the sides of the endless transfer belt, a small structural size of the multi-color printing system is achieved, even if the width of the endless transfer belt for the assigned size of the print medium has a size of up to 1000 mm or more. In this case, the transfer to the print medium can occur in different ways and can be matched to the print medium.

Thus, in one embodiment the print medium is conducted on a guide device in the area of or near the reversing roller used as a tensing and relay roller between the endless transfer belt and a transfer roller. The multi-color toner image can be transferred to the print medium during this passage. This embodiment is particularly suitable for substrates used as the print medium, which are moved beyond the relay roller and the transfer roller.

In accordance with another further embodiment, the layout in the transfer area can accommodate the multi-color toner image of the endless transfer belt in the area of or near the reversing roller used as a tensing and relay roller can be transferred to a transfer roller. The multi-color toner image can be applied from the transfer roller directly to the print medium, which is conducted on a guide device along with it. In this case the printing process can be monitored so that a control print medium formed as a paper web can be conducted between the reversing roller with the endless transfer belt and the transfer roller.

Unequivocal printing of the different partial toner images and their congruent application at the endless transfer belt requires that the running speed of the endless transfer belt and the transport speed of the print medium are matched to each other and are identical. At least those toner printing stations, which are arranged following the first toner printing station in the running direction of the endless transfer belt, can be adjusted and/or synchronized with the arriving partial toner images. To assure this, the printing processes of the toner printing stations can be synchronized with the arriving partial toner images by control devices, wherein start markers of the first partial toner image can be used, for which purpose influencing can be performed so that the transport speed of the print medium can be adjusted and/or regulated. Also, the printing process in the toner printing stations to be passed can be controlled and matched to the arriving partial toner image.

The structural size of the multi-color printing system, along with a very good accessibility of the toner printing stations, can be simply achieved because the running direction of the endless transfer belt extends perpendicularly with respect to the transport direction of the print medium, or the running direction of the endless transfer belt on the entry side of the print medium extends at an acute angle with respect to the transport direction of the print medium.

It is advantageous that an even number of toner print stations is selected and one half is assigned to each one of the exteriors of the two sides of the endless transfer belt, because the linear dimensions of the endless transfer belts are kept small, yet they can still be optimally used for arranging toner printing stations.

With the running direction of the endless transfer belt extending perpendicularly with respect to the transport direction of the print medium, an arrangement is of advantage, which is distinguished because the toner printing stations are assigned horizontally and in pairs to the perpendicularly extending endless transfer belt. In each of the toner printing stations assigned to the return side of the endless transfer belt a reversing roller is provided for matching the running direction of the return side, which runs opposite to that of the advancing side.

The additional reversing rollers for matching the associated running directions of the endless transfer belt can also be assigned to the toner printing stations of the advancing side of the endless transfer belt if the toner printing station used has a different direction of rotation of the final component, which does not agree with the running direction of the return side of the endless transfer belt.

In this case the component of the toner printing station facing the endless transfer belt can be a rotatably taken along or driven photo-conductor.

The alignment of the print medium transport direction and the running direction of the endless transfer belt with the toner printing stations can be arranged so that the toner printing stations are arranged on the endless transfer belt in pairs approximately vertically with respect to the horizontally oriented and moved print medium and for matching the opposite running direction of the sides of the endless transfer belt, points of the rotating photo-conductor which are located diametrically opposite each other contact the endless transfer belt and transfer the partial toner image. In this case, the toner printing stations do not require any reversing rollers, because the two final points have oppositely oriented movement components.

In accordance with a further embodiment, the multi-color printing system can be further simplified if the toner printing stations transfer the partial toner images directly to an endless transfer belt designed as an OPC master belt. Thus the rotatable final components in the form of photo-conductor can be omitted.

The toner printing stations are preferably assembled from partial modules, which are commercially available. Partial exposure, developer and transfer modules are used, wherein the partial exposure module essentially can comprise a photo-conductor, an LED writing head, a corona charge device and an erasing strip.

The partial developer module comprises a developer roller, an application roller, a metering roller, an endless mixing screw, a toner cap, toner cartridges and, if required for the adaptation to the facing running direction of the endless transfer belt, a reversing roller, and a developer corona and a developer belt.

The partial transfer module is formed by the endless transfer belt and a transfer roller arranged on the inside of the endless transfer belt.

The toner printing stations with their components are partially known and are available in different embodiments, they merely need to be adapted to the facing running direction of the endless transport belt and arranged in accordance with the structure of the multi-color printing system. The function of the toner printing stations is known and can also be achieved by different components and arrangements in order to meet the requirements of the multi-color printing system, in accordance with this invention.

Greatly different print media, such as substrate plates made of glass, glass-ceramic materials, ceramic materials, plastic, metal, paper webs, film webs, cardboard and the like can be imprinted in six and more different colors by the novel multi-color printing system.

### BRIEF DESCRIPTION OF THE DRAWINGS

This invention is explained in view of differently constructed multi-color printing systems.

FIG. 1 shows a schematic view of a multi-color printing system with six toner printing stations which transfer partial toner images to an endless transfer belt running in a vertical direction that extends perpendicular to the horizontal transport direction of the print media, wherein the toner application to the respective OPC photo-conductor takes place via a developer belt;

FIG. 2 shows a schematic view of a multi-color printing system similar to the one in FIG. 1 with a running direction of the endless transfer belt opposite the clockwise direction and with the direct transfer of the partial toner images to an OPC master belt;

FIG. 3 shows a multi-color printing system similar to the one shown in FIG. 1 with the running direction of the endless transfer belt extending at an acute angle of >45°, but <90° with respect to the transport direction of the print medium;

FIG. 4 shows a multi-color printing system with the running direction of the endless transfer belt extending at an acute angle of <45° with respect to the transport direction of the print medium; and

FIG. 5 shows one assembly of a toner printing station from partial modules, according to this invention.

### DESCRIPTION OF PREFERRED EMBODIMENTS

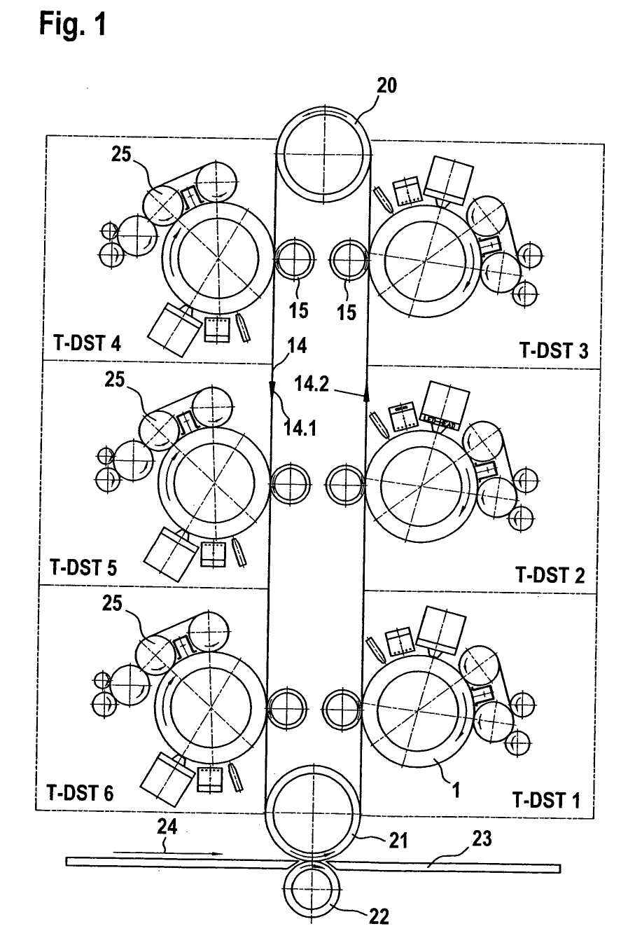

In the multi-color printing system in accordance with FIG. 1, a substrate forming the print medium 24 is conducted on a guide device 23 between a transfer roller 22 and the reversing roller 21 used as relay roller. The relay roller 21 moves the endless transfer belt 14 at the identical speed and transfers the multi-color toner image located on it to the substrate. In this case the transfer roller 22 can press on an additional belt. The vertically aligned endless transfer belt 14 is guided around a further reversing roller 20 at the top, so that it forms an advancing side 14.1, which is moved from the bottom to the top, and a return side 14.2, which is moved from the top to the bottom. In FIG. 1, both reversing rollers 20 and 21 rotate in a counterclockwise direction. Respectively, n/2=3 toner printing stations T-DSt1 to T-DSt3, or T-DSt4 to T-DStn, are assigned to the exteriors of the two sides 14.1 and 14.2. The toner printing stations create differently colored partial toner images, which are combined into the six-colored multi-color toner image. The function of the toner printing stations is known, and their construction is known and commercially available in partial modules. The toner printing station is assembled to form a total module unit. The partial toner image leaves the first toner printing station T-Dst1 on a rotatable photo-conductor 1, which transfers the partial toner image to the endless transfer belt 14 supported on a transfer roller 15, namely to the advancing side 14.1. In the process, the partial toner image is provided a start marker which, together with a control device, controls the transfer of the partial toner images assigned to and created in the subsequent toner printing stations T-DSt2 to T-DStn while passing through the printing stations so that they are transferred, synchronized with the arriving partial toner images or the partial multi-toner image, for example are transferred congruently and with the same registration.

The toner printing stations are arranged horizontally in pairs. The sides 14.1 and 14.2 of the endless transfer belt 14 have oppositely directed running directions. As shown in FIG. 1, for the unequivocal transfer of the partial toner images this requires the photo-conductors 1 of all toner printing stations T-DSt1 to T-DStn to rotate in a clockwise direction and their running direction at the relay or contact point is aligned with the running direction of facing sides 14.1 or 14.2. In the multi-color printing system shown in FIG. 1, this requires the employment of an additional reversing roller 25 in the toner print stations T-DSt4 to T-DStn assigned to the return side 14.2 of the endless transfer belt. However, considered with respect to their functions, the structure of all toner print stations can substantially remain identical. Because the partial toner images on the advancing side 14.1 are transferred to the correspondingly moved endless transfer belt 14 running from the bottom to the top, but on the return side 14.2 from the top to the bottom, the sequence of the components on the photo-conductor 1 must be correspondingly changed to extend from the top to the bottom or from the bottom to the top, in the direction of rotation.

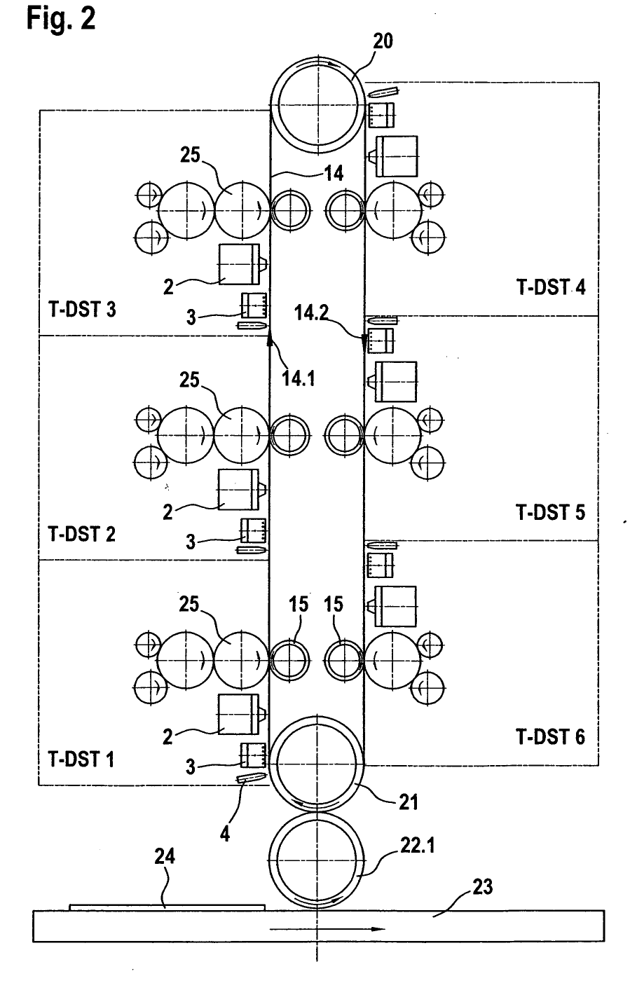

In the multi-color printing system in accordance with FIG. 2, the substrates as the print medium 24 are moved on a guide device 23 embodied as transport table. The contact and the transfer of the multi-color toner image is not performed by the endless transfer belt 14, which itself is embodied as an OPC master belt, but by a transfer roller 22.1.

With the left to right transport direction of the print medium 24, the transfer roller 22.1 must rotate in a counterclockwise direction, and the lower reversing roller 21 of the transfer belt 14, as well as the upper reversing roller 20, must rotate in a clockwise direction. This means that the advancing side 14.1 lies in front of the return side 14.2. With the omission of the photo-conductor 1 and with the same directions of rotation of the components in the toner printing stations as in the multi-color printing system in accordance with FIG. 1, now the reversing rollers 25 must be placed in the toner printing stations T-DSt1 to T-DSt3 in order to maintain the matching of the facing running direction of the endless transfer belt 14. Because the endless transfer belt 14 is embodied as an OPC master belt, wherein the OPC master belt takes over the functions of the photo-conductors 1, the LED writing head 2, the corona charge device 3 and the erasing strip 4 are directly assigned to the OPC master belt and, viewed in the direction of rotation of the final component of the toner printing station, are arranged downstream in the direction of rotation, for example arranged ahead of the taking of a new partial toner image. Otherwise, the horizontal arrangement in pairs of the toner printing stations T-DSt1 and T-DStn, T-DSt2 and T-DSt5, as well as T-DSt3 and T-DSt4 remains unchanged.

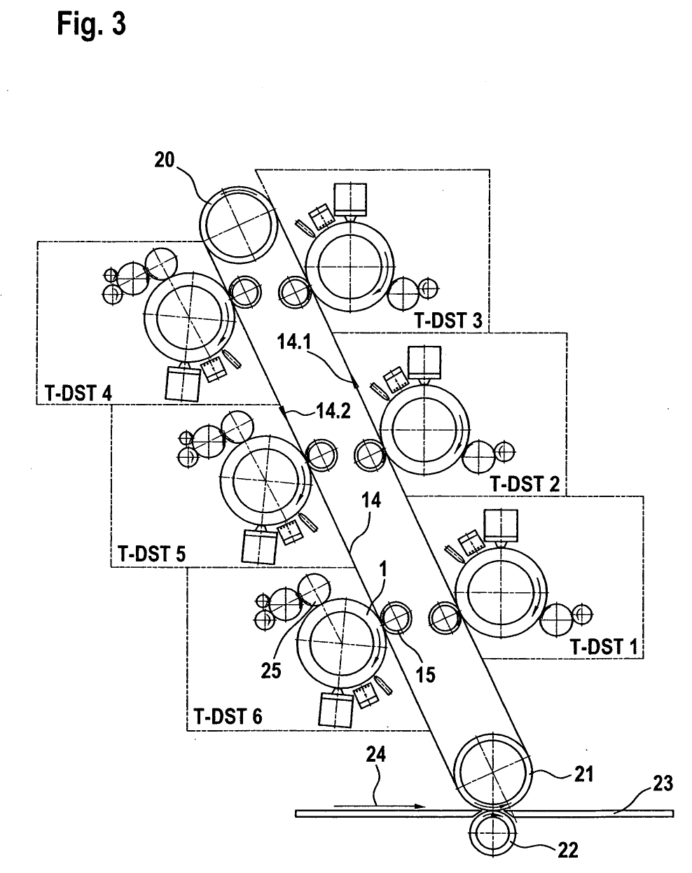

The multi-color printing system in accordance with FIG. 3 differs from the multi-color printing system in accordance with FIG. 1 only because the running direction of the endless transfer belt 14 extends at an acute angle of >45°, but <90° with respect to the transport direction of the printing mechanism 24. Again, reversing rollers 25 are required for the toner printing stations T-DSt4 to T-DStn of the returning side 14.2 of the endless transport belt 14 in order to achieve the matching of the direction of rotation of the photo-conductors 1 to the running direction of the facing returning side 14.2 of the endless transfer belt 14.

The photo-conductors 1 can also be omitted in this embodiment of the multi-color printing system if an OPC master belt is used as the endless transfer belt 14 and the components 2, 3 and 4 of the toner printing stations are assigned to the OPC master belt. The toner printing stations of this multi-color printing system are also easy to access and operate. Also, the structural size of the multi-color printing system also remains small.

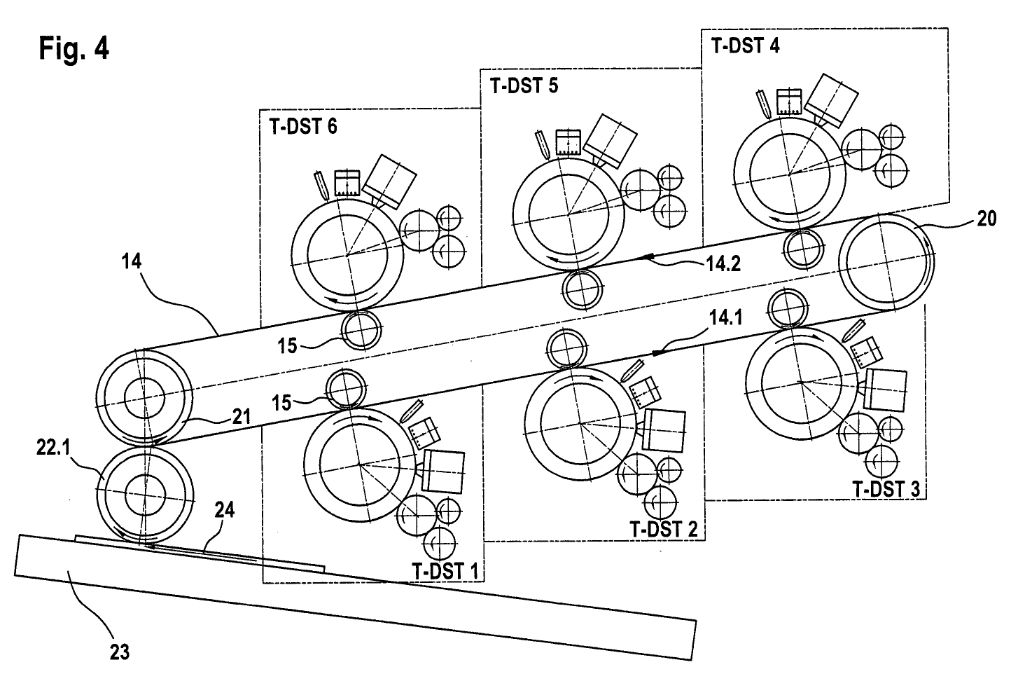

The same also applies to a multi-color printing system in accordance with FIG. 4, wherein the running direction of the endless transport belt 14 extends at an angle <45° with respect to the transport direction of the printing medium 24. In this case the transport direction is preferably determined by the horizontally oriented transport table constituting the guide device 23. The toner printing stations T-DSt1 to T-DStn are located in pairs approximately perpendicularly with respect to the transport direction. With a photo-conductor 1 as the final component and while keeping the direction of rotation of all components of the toner printing station, it is thus possible to use two diametrically oppositely located contact points of the photo-conductors 1 in the area of the advancing side 14.1 and in the area of the returning side 14.2 with the endless transfer belt 14. The contact points do not require reversing rollers in the toner printing stations, because identical movement components and directions between the photo-conductor 1 and the endless transfer belt 14 are automatically provided at the contact points. The arrangement of the components of the toner printing stations, starting with the erasing strip 4, through the corona charging device 3 and the LED head 2 to the final component upstream of the photo-conductor 1, remains identical in the direction of rotation of the photo-conductor 1, starting with the transfer of the partial toner image to the endless transfer belt 14, such as on the right circumferential halves of the photo-conductors 1.

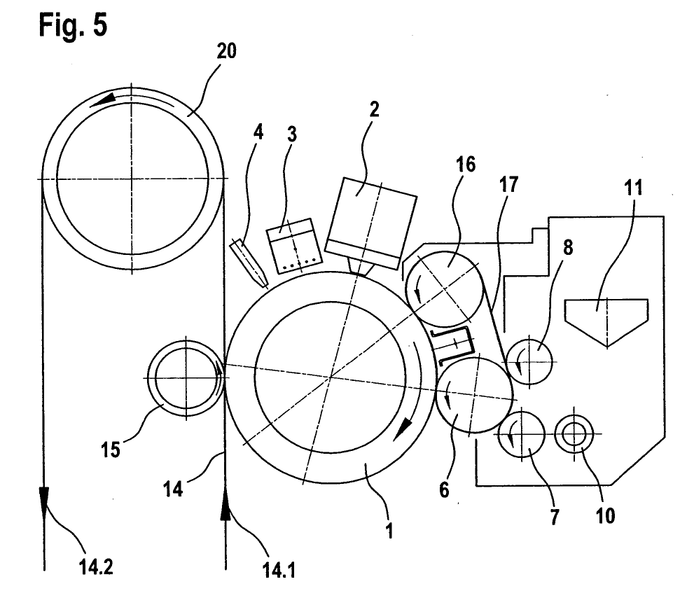

As shown in FIG. 5, the toner printing station, for example T-DSt3, is essentially assembled in the form of a module unit from partial modules which are commercially available. The module unit can comprise a partial exposure module including a photo-conductor 1, an LED head 2, a corona charging device 3 and an eraser strip 4. The partial developer module contains a developer roller 6, an application roller 7, a metering roller 8, an endless mixing screw 10, a toner cap 11, toner cartridges 12 and, if required for the adaptation to the running direction, a reversing roller 25, as well as a developer corona 18 and a developer belt 17.

Together with a transfer roller 15, the endless transfer belt 14 forms a partial transfer module.

The structure of the toner printing stations, for example, can also be put together from other partial modules. There is preferably an identical movement between the final component of the toner printing station and the running direction of the facing side of the endless transfer belt 14. The toner printing stations are distributed over the exteriors of the endless transfer belt 14, and that their partial toner images are transferred, controlled and synchronized with the first partial toner image, to the endless transfer belt 14, or to an OPC master belt provided at this location.

German Patent Reference 103 54 345.7, the priority document corresponding to this invention, and its teachings are incorporated, by reference, into this specification.

1. A multi-color printing system having a plurality of toner printing stations which apply differently colored toner images to at least one side of a transfer medium from which the toner images can be transferred to a print medium that can be contacted with the transfer medium, the multi-color system comprising:
the transfer medium as an endless transfer belt (14) with a running direction extending at an angle with respect to a transport direction of the print medium (24);
the toner printing stations (T-DSt1 to T-DStn) formed as modular units arranged at exteriors of two sides (14.1, 14.2) of the endless transfer belt (14) and matched to opposing running directions of the sides (14.1, 14.2) with a toner image transfer; and
the multicolor toner image of the endless transfer belt (14) transferable one of directly and by way of a transfer roller (22.1) to the print medium (24), which is conducted at a same speed as the endless transfer belt (14).

2. The multi-color printing system in accordance with claim 1, wherein the print medium (24) is conducted on a guide device (23) near a reversing roller (21) acting as a tensing and relay roller between the endless transfer belt (14) and a transfer roller (22), and the multi-color toner image transferable to the print medium (24) during the passage.

3. The multi-color printing system in accordance with claim 1, wherein the multi-color toner image of the endless transfer belt (14) near the reversing roller (21) used as the tensing and relay roller is transferable to the transfer roller (22.1), and the multi-color toner image is applied from the transfer roller (22.1) directly to the print medium (24), which is conducted on a guide device (23).

4. The multi-color printing system in accordance with claim 3, wherein a running speed of the endless transfer belt (14) and the transport speed of the print medium (24) are matched to each other and are identical.

5. The multi-color printing system in accordance with claim 4, wherein at least the toner printing stations (T-DSt2 . . . T-DStn) that follow the first toner printing station (T-DSt1) in the running direction of the endless transfer belt (14) are at least one of adjustable and synchronizable with arriving partial toner images.

6. The multi-color printing system in accordance with claim 5, wherein the running direction of the endless transfer belt (14) extends perpendicularly with respect to the transport direction of the print medium (24).

7. The multi-color printing system in accordance with claim 5, wherein the running direction of the endless transfer belt (14) on an entry side of the print medium (24) extends at an acute angle with respect to the transport direction of the print medium (24).

8. The multi-color printing system in accordance with claim 7, wherein the running speed of at least one of the endless transport belt (14) and the transport speed of the print medium (24) is at least one of adjustable and regulatable.

9. The multi-color printing system in accordance with claim 7, wherein printing processes of the toner printing stations (T-DSt1 . . . T-DStn) are synchronizeable with the arriving partial toner images by control devices.

10. The multi-color printing system in accordance with claim 9, wherein an even number (n) of toner print stations (T-DSt1 . . . T-DStn) is selected and one half is assigned to each one of the exteriors of the two sides (14.1, 14.2) of the endless transfer belt (14).

11. The multi-color printing system in accordance with claim 10, wherein the toner printing stations (T-DSt1 . . . T-DStn) are assigned horizontally and in pairs to the perpendicularly extending endless transfer belt (14), and in each of the toner printing stations (T-DSt4 . . . T-DSt6) assigned to a return side (14.2) of the sides of the endless transfer belt (14) a reversing roller (25) is provided for matching the running direction of the return side (14.2) which is opposite to an advancing side (14.1) of the sides.

12. The multi-color printing system in accordance with claim 10, wherein the toner printing stations (T-DSt1 . . . T-DStn) are assigned horizontally and in pairs to the perpendicularly extending endless transfer belt (14), and in each of the toner printing stations (T-DSt1 . . . T-DSt3) assigned to an advancing side (14.1) of the sides of the endless transfer belt (14) a reversing roller (25) is provided for matching the running direction of the advancing side (14.1), which is opposite to that of a return side (14.2) of the sides.

13. The multi-color printing system in accordance with claim 12, wherein the toner printing stations (T-DSt1 . . . T-DStn) transfer the partial toner image to the endless transfer belt (14) via one of a rotatably driven and a taken along a photo-conductor (1).

14. The multi-color printing system in accordance with claim 10, wherein the toner printing stations (T-DSt1 . . . T-DStn) are arranged on the endless transfer belt (14) in pairs approximately vertically with respect to the horizontally oriented and moved print medium (24) and, for matching the opposite running direction of the sides (14.1, 14.2) of the endless transfer belt (14), points of the rotating photo-conductor (1) which are located diametrically opposite each other contact the endless transfer belt (14) and transfer the partial toner image.

15. The multi-color printing system in accordance with claim 14, wherein the toner printing stations (T-DSt1 . . . T-DStn) transfer the partial toner images directly to an endless transfer belt (14) designed as an OPC master belt.

16. The multi-color printing system in accordance with claim 15, wherein the toner printing stations (T-DSt1 . . . T-DStn) are assembled as a modular unit from partial modules including a partial exposure, a partial developer and a partial transfer module.

17. The multi-color printing system in accordance with claim 16, wherein the partial exposure module comprises a photo-conductor (1), an LED head (2), a corona charge device (3) and an erasing strip (4).

18. The multi-color printing system in accordance with claim 16, wherein the partial developer module comprises at least one of a developer roller (6), an application roller (7), a metering roller (8), an endless mixing screw (10), a toner cap (11), toner cartridges (12) and for an adaptation to the facing running direction of the endless transfer belt (14), a reversing roller (25), a developer corona (18) and a developer belt (17).

19. The multi-color printing system in accordance with claim 16, wherein the partial transfer module is formed by the endless transfer belt (14) and a transfer roller (15).

20. The multi-color printing system in accordance with claim 3, wherein a control print medium is conducted between the reversing roller (21) with the endless transfer belt (14) and the transfer roller (22.1).

21. The multi-color printing system in accordance with claim 20, wherein substrate plates of at least one of a glass, a glass-ceramic material, a ceramic material, a plastic, a metal, a printed circuit board, a paper web, a film web, a cardboard, and a blank can be used as print media.

22. The multi-color printing system in accordance with claim 1, wherein a running speed of the endless transfer belt (14) and the transport speed of the print medium (24) are matched to each other and are identical.

23. The multi-color printing system in accordance with claim 1, wherein at least the toner printing stations (T-DSt2 . . . T-DStn) that follow the first toner printing station (T-DSt1) in the running direction of the endless transfer belt (14) are at least one of adjustable and synchronizable with arriving partial toner images.

24. The multi-color printing system in accordance with claim 1, wherein the running direction of the endless transfer belt (14) extends perpendicularly with respect to the transport direction of the print medium (24).

25. The multi-color printing system in accordance with claim 1, wherein the running direction of the endless transfer belt (14) on an entry side of the print medium (24) extends at an acute angle with respect to the transport direction of the print medium (24).

26. The multi-color printing system in accordance with claim 1, wherein the running speed of at least one of the endless transport belt (14) and the transport speed of the print medium (24) is at least one of adjustable and regulatable.

27. The multi-color printing system in accordance with claim 1, wherein printing processes of the toner printing stations (T-DSt1 . . . T-DStn) are synchronizeable with the arriving partial toner images by control devices.

28. The multi-color printing system in accordance with claim 1, wherein an even number (n) of toner print stations (T-DSt1 . . . T-DStn) is selected and one half is assigned to each one of the exteriors of the two sides (14.1, 14.2) of the endless transfer belt (14).

29. The multi-color printing system in accordance with claim 6, wherein the toner printing stations (T-DSt1 . . . T-DStn) are assigned horizontally and in pairs to the perpendicularly extending endless transfer belt (14), and in each of the toner printing stations (T-DSt4 . . . T-DSt6) assigned to a return side (14.2) of the sides of the endless transfer belt (14) a reversing roller (25) is provided for matching the running direction of the return side (14.2) which is opposite to an advancing side (14.1) of the sides.

30. The multi-color printing system in accordance with claim 6, wherein the toner printing stations (T-DSt1 . . . T-DStn) are assigned horizontally and in pairs to the perpendicularly extending endless transfer belt (14), and in each of the toner printing stations (T-DSt1 . . . T-DSt3) assigned to an advancing side (14.1) of the sides of the endless transfer belt (14) a reversing roller (25) is provided for matching the running direction of the advancing side (14.1), which is opposite to that of a return side (14.2) of the sides.

31. The multi-color printing system in accordance with claim 1, wherein the toner printing stations (T-DSt1 . . . T-DStn) transfer the partial toner image to the endless transfer belt (14) via one of a rotatably driven and a taken along a photo-conductor (1).

32. The multi-color printing system in accordance with claim 7, wherein the toner printing stations (T-DSt1 . . . T-DStn) are arranged on the endless transfer belt (14) in pairs approximately vertically with respect to the horizontally oriented and moved print medium (24) and, for matching the opposite running direction of the sides (14.1, 14.2) of the endless transfer belt (14), points of the rotating photo-conductor (1) which are located diametrically opposite each other contact the endless transfer belt (14) and transfer the partial toner image.

33. The multi-color printing system in accordance with claim 1, wherein the toner printing stations (T-DSt1 . . . T-DStn) transfer the partial toner images directly to an endless transfer belt (14) designed as an OPC master belt.

34. The multi-color printing system in accordance with claim 1, wherein the toner printing stations (T-DSt1 . . . T-DStn) are assembled as a modular unit from partial modules including a partial exposure, a partial developer and a partial transfer module.
